(19) United States
(12) Patent Application Publication
(10) Pub. No.: US 2025/0389907 A1
(43) Pub. Date: Dec. 25, 2025

(54) METHOD FOR PRODUCING OPTICAL MODULE, AND OPTICAL MODULE

(71) Applicant: Panasonic Intellectual Property Management Co., Ltd., Osaka (JP)

(72) Inventors: KOJIRO NAKAMURA, Osaka (JP); KIYOKAZU ITOI, Osaka (JP); TAKAHIRO KUMAKAWA, Kyoto (JP); AYA KUROKAWA, Osaka (JP); DAISUKE SAKURAI, Osaka (JP)

(21) Appl. No.: 19/309,660

(22) Filed: Aug. 26, 2025

Related U.S. Application Data
(63) Continuation of application No. PCT/JP2024/001671, filed on Jan. 22, 2024.

(30) Foreign Application Priority Data
Mar. 7, 2023 (JP) 2023-034765

(51) Int. Cl. G02B 6/42

(52) U.S. Cl. CPC G02B 6/4212; G02B 6/4298

(57) ABSTRACT

A method for producing an optical module includes: a step of bonding an electrode formed on a surface of a substrate and an electrode described on a surface of an optical element via a bump; a step of injecting an optical transparent resin to be cured by light into a gap between the substrate and the optical element; a step of applying light through an optical waveguide, formed on the substrate, toward a light reception unit formed on the optical element to photocure the optical transparent resin located between the optical waveguide and the light reception unit; a step of removing an uncured portion of the optical transparent resin; a step of injecting a encapsulation resin that has a coefficient of thermal expansion smaller than that of the optical transparent resin and is to be cured by heat into the gap between the substrate and the optical element; and a step of thermally curing the encapsulation resin.

### TECHNICAL FIELD

The present invention relates to a method for producing an optical module in which an optical element having a light reception unit or a light emission unit formed therein is flip-chip bonded on a substrate having an optical waveguide formed thereon, and an optical module.

### BACKGROUND ART

Heretofore, flip-chip bonding in which a semiconductor element is mounted on a circuit substrate via bumps has been known as a method for mounting a semiconductor element on a circuit substrate. In flip-chip bonding, by filling a space between a circuit substrate and a semiconductor element with an underfill material, sealing of bump joints and fixing of the circuit substrate and the semiconductor element in portions other than the bump joints are performed.

PTL 1 discloses an optical module in which an optical element having a light reception unit and a light emission unit formed therein is flip-chip bonded via bumps on a substrate having an optical waveguide formed thereon. Since an optical path is formed between the optical waveguide and the light reception unit and the light emission unit, a gap between the substrate and the optical element is filled with an optical transparent resin as an underfill material.

### CITATION LIST

### Patent Literature

PTL 1: Unexamined Japanese Patent Publication No. 2013-4935

### SUMMARY OF THE INVENTION

Since a resin such as an epoxy resin used as an underfill material has large thermal expansion and may cause bump joints to be broken, the underfill material usually contains a filler such as silica having a small coefficient of thermal expansion.

However, in the optical module, if a filler such as silica is contained in the optical transparent resin filled in the gap between the substrate and the optical element, light is scattered or blocked by the filler, so that the filler such as silica cannot be contained in the optical transparent resin.

Thus, the optical transparent resin not containing a filler such as silica has a large coefficient of thermal expansion, which addresses a problem that the bump joints are broken when a thermal stress is applied to the optical transparent resin in, for example, a heat cycle test.

In particular, in a case where an electrode is disposed only on one side of the optical element, since the bump joints are formed on one side of the optical element, when the optical transparent resin thermally expands, the optical element is greatly deformed at the side not constrained by the bump joints, with the bump joints as a fulcrum. Therefore, there is a problem that the bump joints are easily broken due to application of a large stress to the bump joints.

The present invention has been made in view of such a point, and a main object thereof is to provide a method for producing an optical module capable of suppressing breakage of bump joints and the optical module, the optical module having an optical element flip-chip bonded on a substrate having an optical waveguide formed thereon.

A method for producing an optical module according to the present invention is a method for producing an optical module in which an optical element having at least one of a light reception unit and a light emission unit formed on a surface thereof is flip-chip bonded on a substrate having an optical waveguide formed on a surface thereof, the optical element having an electrode formed on the surface thereof, the electrode being disposed only on one side of the optical element, the method including: a step of arranging the substrate and the optical element so that the substrate and the optical element face each other and bonding an electrode formed on a surface of the substrate and the electrode described on the surface of the optical element via a bump; a step of injecting an optical transparent resin to be cured by light into a gap between the substrate and the optical element; a step of applying light through the optical waveguide toward the at least one of the light reception unit and the light emission unit to photocure the optical transparent resin located between the optical waveguide and the at least one of the light reception unit and the light emission unit; a step of removing an uncured portion of the optical transparent resin; a step of injecting a encapsulation resin that has a coefficient of thermal expansion smaller than that of the optical transparent resin and is to be cured by heat into the gap between the substrate and the optical element; and a step of thermally curing the encapsulation resin.

An optical module according to the present invention includes: a substrate having an optical waveguide formed on a surface thereof; and an optical element having at least one of a light reception unit and a light emission unit formed on a surface thereof and being flip-chip bonded on the substrate. An electrode formed on the surface of the optical element is disposed only on one side of the optical element, the substrate and the optical element are arranged to face each other, and an electrode formed on a surface of the substrate and the electrode described on the surface of the optical element are bonded via a bump, and a region that is a gap between the substrate and the optical element and is between the optical waveguide and the at least one of the light reception unit and the light emission unit is sealed with an optical transparent resin, and other regions are sealed with a encapsulation resin having a coefficient of thermal expansion smaller than that of the optical transparent resin.

According to the present invention, it is possible to provide a method for producing an optical module capable of suppressing breakage of bump joints and the optical module, the optical module having an optical element flip-chip bonded on a substrate having an optical waveguide formed thereon.

### BRIEF DESCRIPTION OF THE DRAWINGS

FIG. 1 is a cross-sectional view schematically illustrating a configuration of an optical module according to a first exemplary embodiment of the present invention.

FIG. 2A is a diagram illustrating a configuration of a substrate.

FIG. 2B is a diagram illustrating the configuration of the substrate.

FIG. 2C is a diagram illustrating the configuration of the substrate.

FIG. 3A is a cross-sectional view illustrating a method for producing an optical module according to the first exemplary embodiment.

FIG. 3B is a cross-sectional view illustrating the method for producing an optical module according to the first exemplary embodiment.

FIG. 3C is a cross-sectional view illustrating the method for producing an optical module according to the first exemplary embodiment.

FIG. 3D is a cross-sectional view illustrating the method for producing an optical module according to the first exemplary embodiment.

FIG. 4A is a cross-sectional view illustrating the method for producing an optical module according to the first exemplary embodiment.

FIG. 4B is a cross-sectional view illustrating the method for producing an optical module according to the first exemplary embodiment.

FIG. 4C is a cross-sectional view illustrating the method for producing an optical module according to the first exemplary embodiment.

FIG. 4D is a cross-sectional view illustrating the method for producing an optical module according to the first exemplary embodiment.

FIG. 5 is a cross-sectional view schematically illustrating a configuration of an optical module according to a second exemplary embodiment of the present invention.

FIG. 6A is a cross-sectional view illustrating a method for producing an optical module according to the second exemplary embodiment.

FIG. 6B is a cross-sectional view illustrating the method for producing an optical module according to the second exemplary embodiment.

FIG. 7 is a cross-sectional view schematically illustrating a configuration of an optical module according to a third exemplary embodiment of the present invention.

FIG. 8 is a cross-sectional view schematically illustrating another configuration of the optical module according to the third exemplary embodiment of the present invention.

FIG. 9A is a cross-sectional view illustrating a method for producing an optical module according to the third exemplary embodiment.

FIG. 9B is a cross-sectional view illustrating the method for producing an optical module according to the third exemplary embodiment.

FIG. 9C is a cross-sectional view illustrating the method for producing an optical module according to the third exemplary embodiment.

### DESCRIPTION OF EMBODIMENT

Exemplary embodiments of the present invention will be described below with reference to the drawings.

### First Exemplary Embodiment

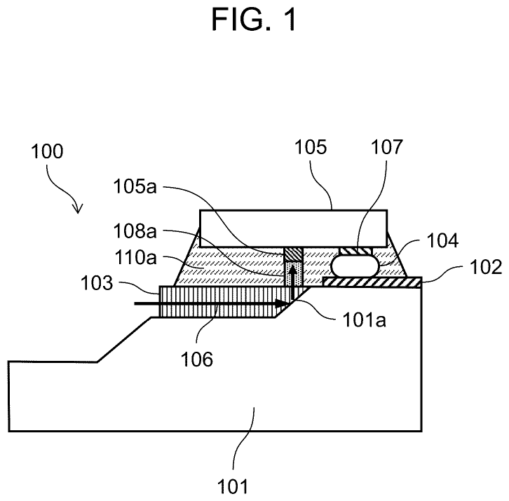

FIG. 1 is a cross-sectional view schematically illustrating a configuration of an optical module according to a first exemplary embodiment of the present invention.

As illustrated in FIG. 1, optical module 100 includes: substrate 101 having optical waveguide 103 formed on its surface; and optical element 105 having light reception unit (or light emission unit) 105a formed on its surface, and optical element 105 is flip-chip bonded on substrate 101. Note that, optical element 105 may include either one or both of the light reception unit and the light emission unit.

Electrode 107 formed on the surface of optical element 105 is disposed only on one side of optical element 105. Substrate 101 and optical element 105 are arranged to face each other, and electrode 102 formed on the surface of substrate 101 and electrode 107 described on the surface of optical element 105 are joined via bump 104. Note that, electrode 102 may be a part of wiring.

A region between optical waveguide 103 and light reception unit (or light emission unit) 105a in a gap between substrate 101 and optical element 105 is sealed with photocured optical transparent resin 108a, and other regions are sealed with thermoset encapsulation resin 110a having a coefficient of thermal expansion smaller than that of optical transparent resin 108a.

Light 106 incident on a core portion of optical waveguide 103 is reflected by mirror portion 101a provided on substrate 101, passes through optical transparent resin 108a, and is received by light reception unit 105a. Alternatively, in a case where light emission unit 105a is formed in optical element 105, the light emitted from light emission unit 105a passes through optical transparent resin 108a, is reflected by mirror portion 101a, and enters the core portion of optical waveguide 103.

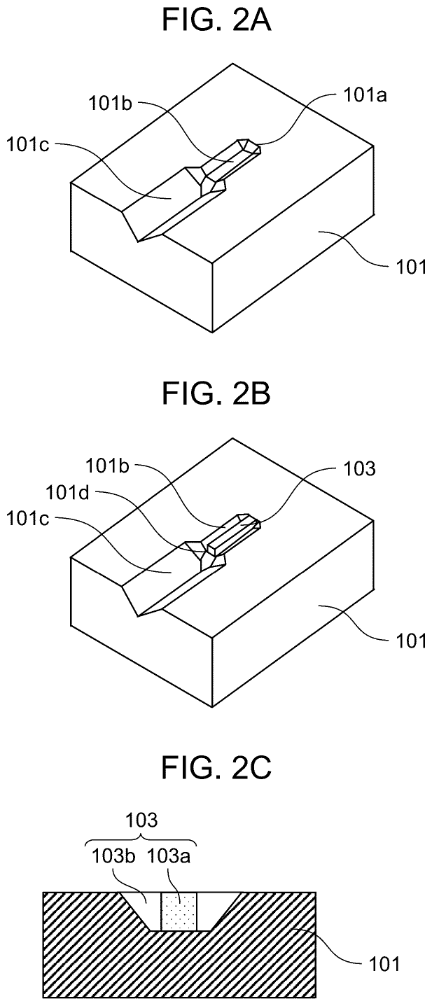

The configuration of substrate 101 will be described in detail with reference to FIGS. 2A to 2C.

As illustrated in FIG. 2A, in the surface of substrate 101, substantially trapezoidal first groove 101b and substantially V-shaped second groove 101c that is continuous with first groove 101b and deeper than first groove 101b are formed. In a distal end portion of first groove 101b, mirror portion 101a for optical path conversion is formed at a position immediately below light reception unit (or light emission unit) 105a of optical element 105.

As illustrated in FIG. 2B, optical waveguide 103 optically coupled to light reception unit (or light emission unit) 105a is disposed in first groove 101b. Optical waveguide 103 extends from mirror portion 101a toward second groove 101c, and is flush with rear end portion 101d of first groove 101b. An external waveguide (not illustrated) optically coupled to optical waveguide 103 is disposed in second groove 101c.

As illustrated in FIG. 2C, optical waveguide 103 includes core portion 103a having a high refractive index of light and having a substantially square cross section, and cladding portion 103b having a refractive index lower than that of core portion 103a. Both left and right surfaces of core portion 103a are covered with cladding portion 103b.

Core portion 103a and cladding portion 103b are formed in predetermined shapes using photolithography or the like after applying a solution to substrate 101 by a spin coating method or the like and subjecting it to thermal treatment, the solution being obtained by mixing an organic material such as a poly methyl methacrylate (PMMA) resin or a polycarbonate resin in an organic solvent.

Substrate 101 needs to have rigidity in order to avoid the influence of heat generated when optical element 105 is flip-chip bonded on the substrate and the influence of stress caused by the use environment. In addition, in the optical module, it is necessary to mount optical element 105 with high accuracy and to suppress positional shift of optical element 105 being used as much as possible. Therefore, it is preferable to use a silicon substrate as substrate 101. The silicon substrate has excellent flatness and enables highly accurate etching of a groove on its surface using the crystal orientation, so that mirror portion 101a and optical waveguide 103 can be arranged in the processed groove with high accuracy.

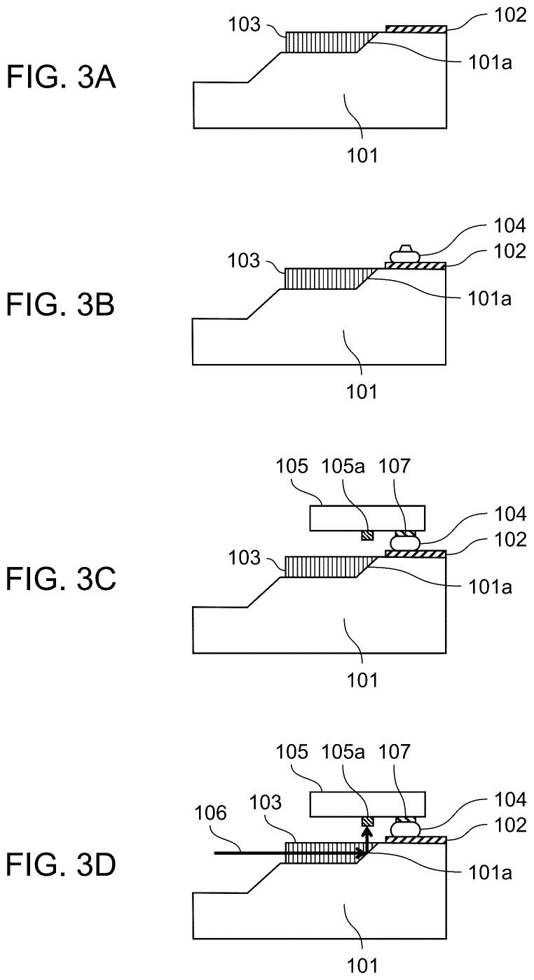

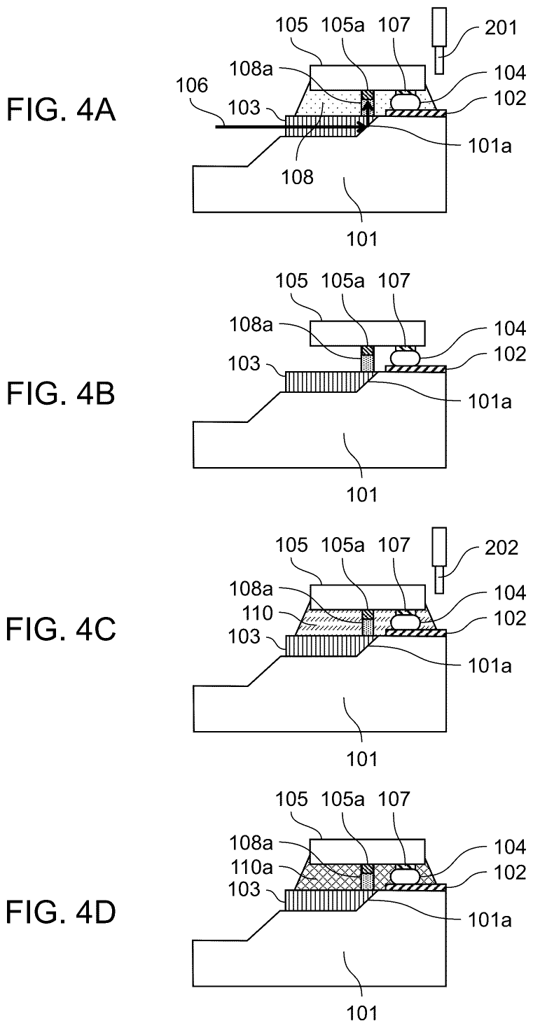

Next, a method for producing optical module 100 according to the first exemplary embodiment will be described with reference to FIGS. 3A to 3D and FIGS. 4A to 4D.

First, as illustrated in FIG. 3A, substrate 101 having optical waveguide 103 and electrode 102 formed on its surface is prepared. Note that, electrode 102 may be a part of wiring.

Next, as illustrated in FIG. 3B, bump 104 is formed on electrode 102. A bump material used for flip-chip connection such as Au or AuSn is used as bump 104. Note that, bump 104 may be formed on light reception unit (or light emission unit) 105a of optical element 105 instead of bump 104 formed on electrode 102 of substrate 101.

Next, as illustrated in FIG. 3C, substrate 101 and optical element 105 are arranged to face each other, and electrode 102 formed on the surface of substrate 101 and electrode 107 described on the surface of optical element 105 are bonded via bump 104. As a result, optical element 105 is flip-chip bonded on substrate 101. The bump can be bonded by ultrasonic bonding, thermocompression bonding, or the like.

Next, as illustrated in FIG. 3D, light 106 is applied from the outside to optical waveguide 103 formed on substrate 101. Light 106 thus applied passes through optical waveguide 103, is bent at 90 degrees by mirror 101a, and reaches light reception unit (or light emission unit) 105a of optical element 105. The wavelength of light 106 to be applied is preferably a wavelength at which optical transparent resin 108 to be described later is photocured, and is preferably an ultraviolet ray or an infrared ray.

Next, as illustrated in FIG. 4A, while light is applied through optical waveguide 103 toward light reception unit (or light emission unit) 105a, optical transparent resin 108 to be cured with light is injected from needle 201 into the gap between substrate 101 and optical element 105. At this time, in optical transparent resin 108 thus injected, only a portion applied with light 106, that is, optical transparent resin 108 located between optical waveguide 103 and light reception unit (or light emission unit) 105a is photocured. As a result, the region between optical waveguide 103 and light reception unit (or light emission unit) 105a is optically coupled by photocured optical transparent resin 108a.

Note that, optical transparent resin 108 does not necessarily have to be injected into the entire region of the gap between substrate 101 and optical element 105, and may be injected into at least a region including the region between optical waveguide 103 and light reception unit (or light emission unit) 105a.

As optical transparent resin 108 to be cured with light, for example, an elastomer-based resin, a polyimide-based resin, an epoxy-based resin, a silicone-based resin, a urethane-based resin, a polymer-based resin, an acryl-based resin, a polyolefin-based resin, or the like can be used. Such optical transparent resin 108 does not contain a filler such as silica, and the coefficient of thermal expansion of optical transparent resin 108 is usually 40 ppm to 400 ppm/° C. at a temperature lower than or equal to the glass transition temperature. Note that, optical transparent resin 108 may be cured with light and heat.

Alternatively, instead of injecting optical transparent resin 108 while applying light through optical waveguide 103 toward light reception unit (or light emission unit) 105a, optical transparent resin 108 may be photocured by injecting optical transparent resin 108 into the gap between substrate 101 and optical element 105 and then applying light through optical waveguide 103 toward light reception unit (or light emission unit) 105a.

Next, as illustrated in FIG. 4B, an uncured portion of optical transparent resin 108 is removed with a chemical solution. By removing the uncured portion, only photocured optical transparent resin 108a remains between substrate 101 and optical element 105.

Next, as illustrated in FIG. 4C, encapsulation resin 110 is injected from needle 202 into the gap between substrate 101 and optical element 105. A resin selected as encapsulation resin 110 is one that has a coefficient of thermal expansion smaller than that of optical transparent resin 108 and is cured by heat. A resin used as such encapsulation resin 110 is, for example, an epoxy resin containing a filler such as silica, and the coefficient of thermal expansion of encapsulation resin 110 is usually 20 ppm to 35 ppm at a temperature lower than or equal to the glass transition temperature.

Finally, as illustrated in FIG. 4D, encapsulation resin 110 is thermally cured by heating encapsulation resin 110. As a result, optical module 100 having the structure illustrated in FIG. 1 is formed.

In the first exemplary embodiment, only the region between optical waveguide 103 and light reception unit (or light emission unit) 105a is sealed with photocured optical transparent resin 108a, and other regions are sealed with encapsulation resin 110a having a coefficient of thermal expansion smaller than that of optical transparent resin 108a. Thus, substantially the entire region of optical element 105 is sealed with encapsulation resin 110a having a small coefficient of thermal expansion. As a result, even when a thermal stress is applied to encapsulation resin 110a in a heat cycle test or the like, it is possible to suppress breakage of a joint for bump 104 (hereinafter referred to as a “bump joint”).

In addition, as illustrated in FIG. 1, even when electrode 107 is disposed only on one side of optical element 105 and thus a bump joint is formed on one side of optical element 105, thermal expansion of encapsulation resin 110a is so small that optical element 105 is not greatly deformed on the side, not constrained by the bump joint, with the bump joint as a fulcrum. Therefore, no large stress is applied to the bump joint, and thus breakage of the bump joint can be suppressed.

### Second Exemplary Embodiment

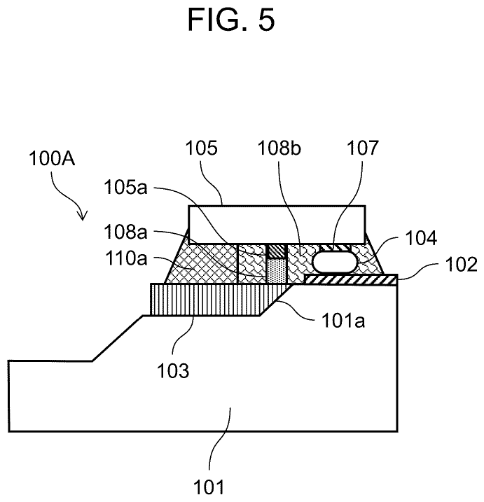

FIG. 5 is a cross-sectional view schematically illustrating a configuration of an optical module according to a second exemplary embodiment of the present invention.

As illustrated in FIG. 5, optical module 100A includes: substrate 101 having optical waveguide 103 formed on its surface; and optical element 105 having light reception unit (or light emission unit) 105a formed on its surface, and optical element 105 is flip-chip bonded on substrate 101. Note that, optical element 105 may include either one or both of the light reception unit and the light emission unit.

Electrode 107 formed on the surface of optical element 105 is disposed only on one side of optical element 105. Substrate 101 and optical element 105 are arranged to face each other, and electrode 102 formed on the surface of substrate 101 and electrode 107 described on the surface of optical element 105 are joined via bump 104. Note that, electrode 102 may be a part of wiring.

In the gap between substrate 101 and optical element 105, a region between optical waveguide 103 and light reception unit (or light emission unit) 105a is sealed with photocured optical transparent resin 108a, a region including a joint for bump 104 (hereinafter referred to as a “bump joint”) is sealed with the thermoset optical transparent resin 108b, and a region on a side facing the bump joint of optical element 105 is sealed with thermoset encapsulation resin 110a having a coefficient of thermal expansion smaller than those of optical transparent resins 108a, 108b.

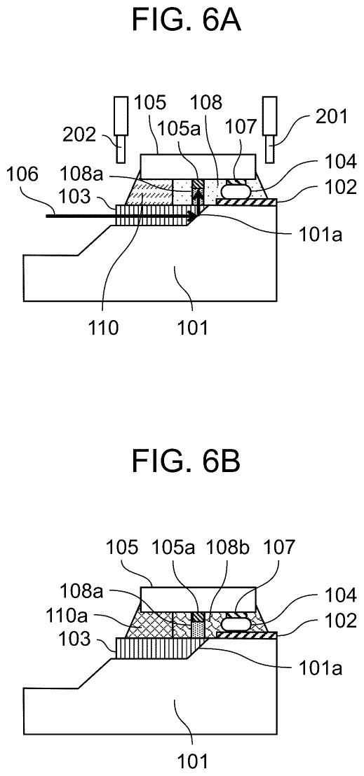

Next, a method for producing optical module 100A according to the second exemplary embodiment will be described with reference to FIGS. 6A and 6B.

First, as in the steps illustrated in FIGS. 3A to 3C, substrate 101 and optical element 105 are arranged to face each other, and electrode 102 formed on the surface of substrate 101 and electrode 107 described on the surface of optical element 105 are bonded via bump 104.

Next, as illustrated in FIG. 6A, while light is applied through optical waveguide 103 toward light reception unit (or light emission unit) 105a, optical transparent resin 108 to be cured with light and heat is injected using needle 201 into the gap between substrate 101 and optical element 105 from one side of optical element 105 where electrode 107 is disposed, and encapsulation resin 110 to be cured with heat and having a coefficient of thermal expansion smaller than that of optical transparent resin 108 is injected using needle 202 from the side facing one side of optical element 105. At this time, in optical transparent resin 108 thus injected, only a portion applied with light 106, that is, optical transparent resin 108 located between optical waveguide 103 and light reception unit (or light emission unit) 105a is photocured.

Note that, as optical transparent resin 108 to be cured with light and heat, for example, an elastomer-based resin, a polyimide-based resin, an epoxy-based resin, a silicone-based resin, a urethane-based resin, a polymer-based resin, an acryl-based resin, a polyolefin-based resin, or the like can be used. Such optical transparent resin 108 does not contain a filler such as silica, and the coefficient of thermal expansion of optical transparent resin 108 is usually 40 ppm to 400 ppm/° C. at a temperature lower than or equal to the glass transition temperature.

Next, as illustrated in FIG. 6B, an uncured portion of optical transparent resin 108 and encapsulation resin 110 are thermally cured. As a result, optical module 100A having the structure illustrated in FIG. 5 is formed.

Note that, the step of injecting optical transparent resin 108 and the step of injecting encapsulation resin 110 do not necessarily have to start simultaneously as long as encapsulation resin 110 is injected at least at timing when optical transparent resin 108 between optical waveguide 103 and light reception unit (or light emission unit) 105a is photocured before encapsulation resin 110 reaches between optical waveguide 103 and light reception unit (or light emission unit) 105a. As a result, the region between optical waveguide 103 and light reception unit (or light emission unit) 105a can be optically coupled by photocured optical transparent resin 108a. The above timing can be implemented by adjusting the injection pressure and injection rate of each of optical transparent resin 108 and encapsulation resin 110, the injection start time of both, and the like.

In the second exemplary embodiment, the region between optical waveguide 103 and light reception unit (or light emission unit) 105a and the region including the bump joint are respectively sealed with optical transparent resin 108a and optical transparent resin 108b obtained by photocuring and thermally curing optical transparent resin 108, respectively, and the region on the side facing the bump joint of optical element 105 is sealed with encapsulation resin 110a having a coefficient of thermal expansion smaller than those of optical transparent resins 108a, 108b. Therefore, as illustrated in FIG. 5, even when the bump joint is formed on one side of optical element 105, the region on the side facing the bump joint is sealed with encapsulation resin 110a having small thermal expansion, so that optical element 105 is not greatly deformed on the side, not constrained by the bump joint, with the bump joint as a fulcrum. As a result, no large stress is applied to the bump joint, and thus breakage of the bump joint can be suppressed.

Further, while the step of removing uncured optical transparent resin 108 is required in the first exemplary embodiment, such a step is no longer required in the second exemplary embodiment, so that the manufacturing process of optical module 100A can be simplified.

### Third Exemplary Embodiment

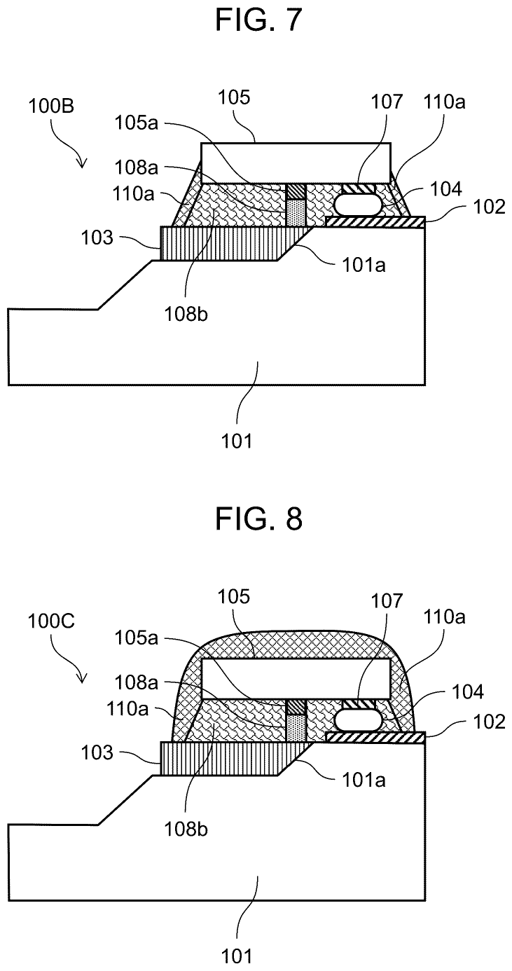

FIG. 7 is a cross-sectional view schematically illustrating a configuration of an optical module according to a third exemplary embodiment of the present invention.

As illustrated in FIG. 7, optical module 100B includes: substrate 101 having optical waveguide 103 formed on its surface; and optical element 105 having light reception unit (or light emission unit) 105a formed on its surface, and optical element 105 is flip-chip bonded on substrate 101. Note that, optical element 105 may include either one or both of the light reception unit and the light emission unit.

Electrode 107 formed on the surface of optical element 105 is disposed only on one side of optical element 105. Substrate 101 and optical element 105 are arranged to face each other, and electrode 102 formed on the surface of substrate 101 and electrode 107 described on the surface of optical element 105 are joined via bump 104. Note that, electrode 102 may be a part of wiring.

A region between optical waveguide 103 and light reception unit (or light emission unit) 105a in a gap between substrate 101 and optical element 105 is sealed with photocured optical transparent resin 108a, and other regions are sealed with thermoset optical transparent resin 108b. Further, around optical element 105, one side facing a joint for bump 104 (hereinafter referred to as a “bump joint”) is sealed with encapsulation resin 110a having a coefficient of thermal expansion smaller than those of optical transparent resins 108a, 108b.

As illustrated in FIG. 7, one side on the bump joint side may also be sealed with encapsulation resin 110a. Alternatively, as illustrated in FIG. 8, not only the periphery of optical element 105 but also the entire optical element 105 may be sealed with encapsulation resin 110a.

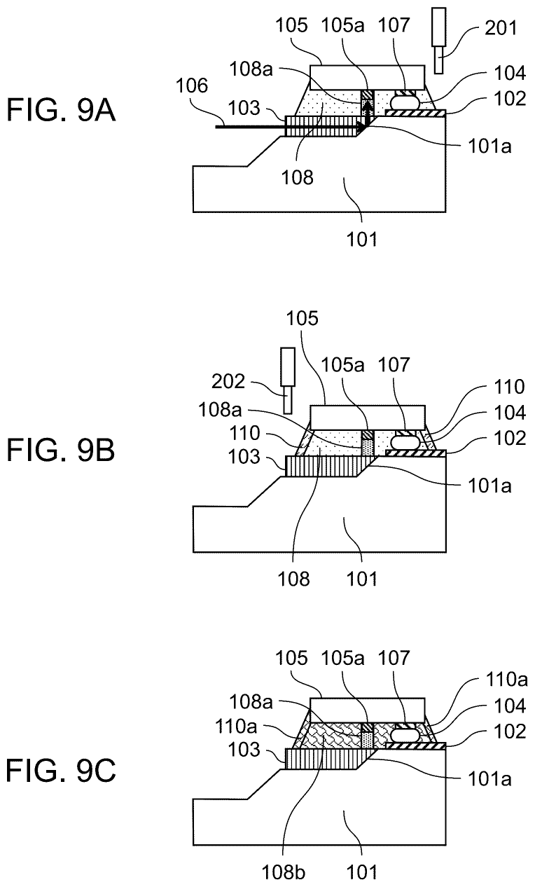

Next, a method for producing optical module 100B according to the third exemplary embodiment will be described with reference to FIGS. 9A to 9C.

First, as in the steps illustrated in FIGS. 3A to 3C, substrate 101 and optical element 105 are arranged to face each other, and electrode 102 formed on the surface of substrate 101 and electrode 107 described on the surface of optical element 105 are bonded via bump 104.

Next, as illustrated in FIG. 9A, while light is applied through optical waveguide 103 toward light reception unit (or light emission unit) 105a, optical transparent resin 108 to be cured with light and heat is injected from needle 201 into the gap between substrate 101 and optical element 105 to photocure optical transparent resin 108 located between optical waveguide 103 and light reception unit (or light emission unit) 105a. As a result, the region between optical waveguide 103 and light reception unit (or light emission unit) 105a is optically coupled by photocured optical transparent resin 108a.

Note that, optical transparent resin 108 located between optical waveguide 103 and light reception unit (or light emission unit) 105a may be photocured by injecting optical transparent resin 108 to be cured with light and heat into the gap between substrate 101 and optical element 105 and then applying light through optical waveguide 103 toward light reception unit (or light emission unit) 105a.

Next, as illustrated in FIG. 9B, encapsulation resin 110, which has a coefficient of thermal expansion smaller than those of optical transparent resins 108a, 108b and is to be cured by heat, is applied from needle 202 to a side, around optical element 105, facing one side of optical element 105 where electrode 107 is disposed. Note that, the side of optical element 105 where electrode 107 is disposed may also be applied with encapsulation resin 110. In addition, in order to form optical module 100C illustrated in FIG. 8, not only the periphery of optical element 105 but also the entire optical element 105 may be applied with encapsulation resin 110.

Next, as illustrated in FIG. 9C, an uncured portion of optical transparent resin 108 and encapsulation resin 110 are thermally cured. As a result, optical module 100B having the structure illustrated in FIG. 7 is formed.

In the third exemplary embodiment, as illustrated in FIG. 7 and FIG. 8, the gap between substrate 101 and optical element 105 except for the portion of optical transparent resin 108a that is photocured earlier is sealed with optical transparent resin 108b that is thermally cured later, and at least one side of optical element 105 facing the bump joint is sealed with encapsulation resin 110a having a coefficient of thermal expansion smaller than those of optical transparent resins 108a, 108b. Therefore, even when the bump joint is formed on one side of optical element 105, the region on the side facing the bump joint is sealed with encapsulation resin 110a having small thermal expansion, so that optical element 105 is not greatly deformed on the side, not constrained by the bump joint, with the bump joint as a fulcrum. As a result, no large stress is applied to the bump joint, and thus breakage of the bump joint can be suppressed.

Further, while the step of removing uncured optical transparent resin 108 is required in the first exemplary embodiment, such a step is no longer required in the third exemplary embodiment, so that the manufacturing process of optical modules 100B, 100C can be simplified.

Although the present invention has been described heretofore with reference to preferred exemplary embodiments, the above-mentioned descriptions are not limiting items, and it is needless to say that various modifications are conceivable. For example, in the first to third exemplary embodiments described above, light is applied through optical waveguide 103 toward light reception unit (or light emission unit) 105a to photocure optical transparent resin 108; however, in a case where light emission unit 105a is formed on the surface of optical element 105, light may be applied from light emission unit 105a toward optical waveguide 103 to photocure optical transparent resin 108 located between optical waveguide 103 and light emission unit 105a.

### REFERENCE MARKS IN THE DRAWINGS

100, 100A, 100B, 100C: optical module
101: substrate
101a: mirror portion
101b: first groove
101c: second groove
101d: rear end portion
102: electrode (part of wiring)
103: optical waveguide
103a: core portion
103b: cladding portion
104: bump
105: optical element
105a: light reception unit (or light emission unit)
106: light
107: electrode
108: optical transparent resin
108a: photocured optical transparent resin
108b: thermally cured optical transparent resin
110: encapsulation resin
110a: thermally cured encapsulation resin
201, 202: needle

1. A method for producing an optical module in which an optical element having at least one of a light reception unit and a light emission unit formed on a surface thereof is flip-chip bonded on a substrate having an optical waveguide formed on a surface thereof,
the optical element having an electrode formed on the surface thereof, the electrode being disposed only on one side of the optical element, the method comprising:
a step of arranging the substrate and the optical element so that the substrate and the optical element face each other and bonding an electrode formed on a surface of the substrate and the electrode described on the surface of the optical element via a bump;
a step of injecting an optical transparent resin to be cured by light into a gap between the substrate and the optical element;
a step of applying light through the optical waveguide toward the at least one of the light reception unit and the light emission unit to photocure the optical transparent resin located between the optical waveguide and the at least one of the light reception unit and the light emission unit;
a step of removing an uncured portion of the optical transparent resin;
a step of injecting a encapsulation resin that has a coefficient of thermal expansion smaller than that of the optical transparent resin and is to be cured by heat into the gap between the substrate and the optical element; and
a step of thermally curing the encapsulation resin.

2. The method for producing an optical module according to claim 1, wherein the step of photocuring the optical transparent resin is performed in the step of injecting the optical transparent resin while the light is applied through the optical waveguide toward the at least one of the light reception unit and the light emission unit.

3. A method for producing an optical module in which an optical element having at least one of a light reception unit and a light emission unit formed on a surface thereof is flip-chip bonded on a substrate having an optical waveguide formed on a surface thereof,
the optical element having an electrode formed on a surface thereof, the electrode being disposed only on one side of the optical element, the method comprising:
a step of arranging the substrate and the optical element so that the substrate and the optical element face each other and bonding an electrode formed on a surface of the substrate and the electrode described on the surface of the optical element via a bump;
a step of injecting an optical transparent resin to be cured by light and heat into a gap between the substrate and the optical element from one side of the optical element where the electrode is disposed while applying light through the optical waveguide toward the at least one of the light reception unit and the light emission unit;
a step of injecting a encapsulation resin that has a coefficient of thermal expansion smaller than that of the optical transparent resin and is to be cured by heat from a side facing the one side of the optical element; and
a step of thermally curing an uncured portion of the optical transparent resin and the encapsulation resin, wherein
the step of injecting the optical transparent resin and the step of injecting the encapsulation resin are performed at least at timing when the optical transparent resin between the optical waveguide and the at least one of the light reception unit and the light emission unit is photocured before the encapsulation resin reaches between the optical waveguide and the at least one of the light reception unit and the light emission unit.

4. The method for producing an optical module according to claim 3, wherein the step of injecting the optical transparent resin and the step of injecting the encapsulation resin start simultaneously.

5. A method for producing an optical module in which an optical element having at least one of a light reception unit and a light emission unit formed on a surface thereof is flip-chip bonded on a substrate having an optical waveguide formed on a surface thereof,
the optical element having an electrode formed on a surface thereof, the electrode being disposed only on one side of the optical element, the method comprising:
a step of arranging the substrate and the optical element so that the substrate and the optical element face each other and bonding an electrode formed on a surface of the substrate and the electrode described on the surface of the optical element via a bump;
a step of injecting an optical transparent resin to be cured by light and heat into a gap between the substrate and the optical element;
a step of applying light through the optical waveguide toward the at least one of the light reception unit and the light emission unit to photocure the optical transparent resin located between the optical waveguide and the at least one of the light reception unit and the light emission unit;
a step of applying a encapsulation resin that has a coefficient of thermal expansion smaller than that of the optical transparent resin and is to be cured by heat to a side, around the optical element, facing the one side of the optical element where the electrode is disposed; and
a step of thermally curing an uncured portion of the optical transparent resin and the encapsulation resin.

6. The method for producing an optical module according to claim 5, wherein in the step of applying the encapsulation resin, the encapsulation resin is applied to cover all of the optical element including a periphery of the optical element.

7. The method for producing an optical module according to claim 5, wherein the step of photocuring the optical transparent resin is performed in the step of injecting the optical transparent resin while the light is applied through the optical waveguide toward the at least one of the light reception unit and the light emission unit.

8. The method for producing an optical module according to claim 1, wherein the light emission unit is formed on the surface of the optical element, and
instead of applying light through the optical waveguide toward the at least one of the light reception unit and the light emission unit, light is applied from the light emission unit toward the optical waveguide to photocure the optical transparent resin between the optical waveguide and the light emission unit.

9. An optical module comprising:
a substrate having an optical waveguide formed on a surface thereof; and
an optical element having at least one of a light reception unit and a light emission unit formed on a surface thereof and being flip-chip bonded on the substrate, wherein
an electrode formed on the surface of the optical element is disposed only on one side of the optical element,
the substrate and the optical element are arranged to face each other, and an electrode formed on a surface of the substrate and the electrode described on the surface of the optical element are bonded via a bump, and
a region that is a gap between the substrate and the optical element and is between the optical waveguide and the at least one of the light reception unit and the light emission unit is sealed with an optical transparent resin, and other regions are sealed with a encapsulation resin having a coefficient of thermal expansion smaller than that of the optical transparent resin.

10. An optical module comprising:
a substrate having an optical waveguide formed on a surface thereof; and
an optical element having at least one of a light reception unit and a light emission unit formed on a surface thereof and being flip-chip bonded on the substrate, wherein
an electrode formed on the surface of the optical element is disposed only on one side of the optical element,
the substrate and the optical element are arranged to face each other, and an electrode formed on a surface of the substrate and the electrode described on the surface of the optical element are bonded via a bump, and
a region that is a gap between the substrate and the optical element and includes a region between the optical waveguide and the at least one of the light reception unit and the light emission unit and a joint for the bump is sealed with an optical transparent resin, and a region on a side, facing the joint for the bump, of the optical element is sealed with a encapsulation resin having a coefficient of thermal expansion smaller than that of the optical transparent resin.

11. An optical module comprising:
a substrate having an optical waveguide formed on a surface thereof; and
an optical element having at least one of a light reception unit and a light emission unit formed on a surface thereof and being flip-chip bonded on the substrate, wherein
an electrode formed on the surface of the optical element is disposed only on one side of the optical element,
the substrate and the optical element are arranged to face each other, and an electrode formed on a surface of the substrate and the electrode described on the surface of the optical element are bonded via a bump, and
a region that is a gap between the substrate and the optical element and is between the optical waveguide and the at least one of the light reception unit and the light emission unit is sealed with a photocured optical transparent resin and other regions are sealed with a thermoset optical transparent resin, and a side, around the optical element, facing the joint for the bump is sealed with a encapsulation resin having a coefficient of thermal expansion smaller than that of the optical transparent resin.

12. The optical module according to claim 11, wherein all of the optical element including a periphery of the optical element is sealed with the encapsulation resin.
